(19) United States
(12) Patent Application Publication
(10) Pub. No.: US 2002/0085379 A1
(43) Pub. Date: Jul. 4, 2002

(54) Surface light source generator

(76) Inventors: Wei-Kuo Han, Hsinchu (TW); Johnson Su, Hsinchu (TW); Ye-Jung Tang, Yunghe City (TW); Adrian Wing Fai Lo, Hsinchu (TW); Fei-Chang Hwang, Miaoli City (TW)

Correspondence Address: LAW OFFICE OF LIAUH & ASSOC., 4224 WAIALAE AVE, STE 5-388, HONOLULU, HI, 96816

(21) Appl. No.: 09/940,397

(22) Filed: Aug. 27, 2001

(30) Foreign Application Priority Data
Nov. 13, 2000 (TW) 89123939

(51) Int. Cl. F21S 2/00

(52) U.S. Cl. 362/227; 362/555

(57) ABSTRACT

The invention is a surface light source generator that can provide surface light with a high luminosity and uniformity and a small dispersion angle. The invention uses the light emitting diodes (LEDs) for industrial standard light bulb packaging as its basis. By redesigning the shape of the LED elements (e.g., hexagonal pillars, quadrangle pillars or triangular pillars) and disposing a plurality of same type LEDs together, a surface type illuminator comprised of many closely packed LED elements is formed. Using the convergent effect of the convex lens on top of the LED elements, the light dispersion angle is controlled within 15 degrees. Such a technique of packing many LED elements together can increase the unit area luminosity of the surface light source generator and, at the same time, achieve a high luminosity and uniformity.

### BACKGROUND OF THE INVENTION

1. Field of Invention

The present invention relates to a light emitting device and, in particular, to a light source generator that can generate light with a high luminosity and uniformity and a small dispersion angle for the application in backlit projecting displays.

2. Related Art

For some devices that need proper light sources, such as projectors or backlit projecting displays, they rely on light source generators to obtain the light for projection. The light source in such a device has to have such characters as a high luminosity, a high uniformity and a small dispersion angle in order to provide a clear image without dark areas and obvious projecting profiles.

The surface light source generators known to the prior art are:

1. As shown in FIG. 1, most LCD projectors use metal halogen light or high pressure mercury light. Using a parabolic reflecting surface 10, the light from the light source is reflected into parallel surface beams. Due to the area between the poles, the central area of the light source will have a dark area so that the light intensity distribution is not homogeneous and has a large gradient. In order to make the emanating light more homogeneous, two sets of array convex lenses 101, 102 have to be installed to project the light to an LCD 103. This device generates a lot of heat and thus requires a good ventilation. The lifetime of the light bulb is much shorter.

2. Another similar light source generator, as shown in FIG. 2, is a light emitting diode (LED) array 12 used in Xerox machines. This type of LED array 12 utilizes packaging technologies to dispose LEDs on a lead frame in the manufacturing process. In front of each LED 121 is installed with a convex lens 131, which is an element of an array convex lens 13. Its function is to converge light into parallel beams, forming a surface light source. Nevertheless, the defect of this method is that when some LED 121 is out of order, the whole array convex lens 13 has to be removed in order to remove the defective LED 121 from the leader frame and to reinstall a new LED 121 using an IC wiring device.

Finally, the array convex lens 13 is put back on. The whole process is rather time-consuming and costly.

### SUMMARY OF THE INVENTION

It is a primary object of the invention to provide a surface light source generator with a high luminosity and uniformity and a small dispersion angle.

It is another object of the invention to provide a surface light source generator that is easy to maintain and requires cheaper maintenance costs.

The present invention obtains a surface light source generator comprised of many closely packed LED elements by changing the shapes of the LED elements and disposing the same type LED elements in a compact pattern. According to a preferred embodiment of the invention, many LED elements in a hexagonal pillar shape are closely put together in rows to form a surface light source generator. Through the convergent effects of the convex lenses on top of the LED elements (controlling the dispersion angles within 15 degrees according to the refraction principle), a homogeneous and bright surface light source is given.

The LED elements used to form the surface light source generator of the invention are soldered and installed in holes formed on a circuit board. By controlling the spans between holes, the LED elements can be closely disposed. Even if any LED element is out of order, a simple soldering tool such as a solder can be used to replace. Therefore, the maintenance is fairly simple, quick and cheap.

### BRIEF DESCRIPTION OF THE DRAWINGS

The present invention will become more fully understood from the detailed description given hereinbelow illustration only, and thus are not limitative of the present invention, and wherein:

FIG. 1 shows the structure of a conventional light source generating device;

FIG. 2 shows the structure of another conventional light source generating device;

FIG. 3 is a decomposed structural view according to the first embodiment of the invention;

FIG. 4 is a side view of the structure of the invention;

FIG. 5 shows a structure according to the second embodiment of the invention;

FIG. 6 shows a structure according to the third embodiment of the invention;

FIG. 7 shows a structure according to the fourth embodiment of the invention;

FIG. 8 shows the experimental sampling positions of the invention; and

FIG. 9 shows a structure according to the last embodiment of the invention.

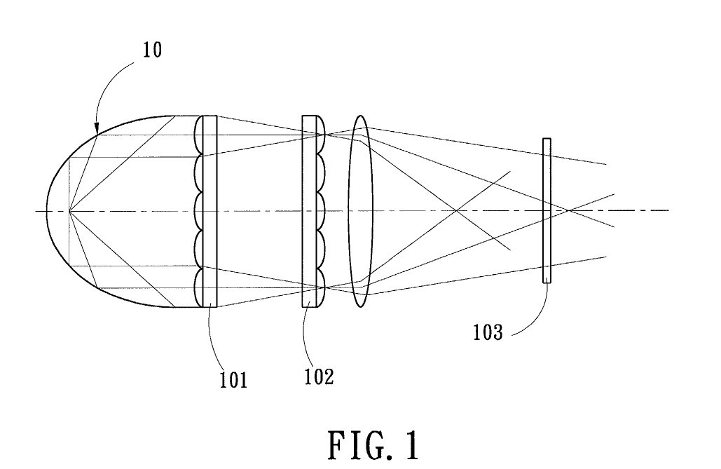

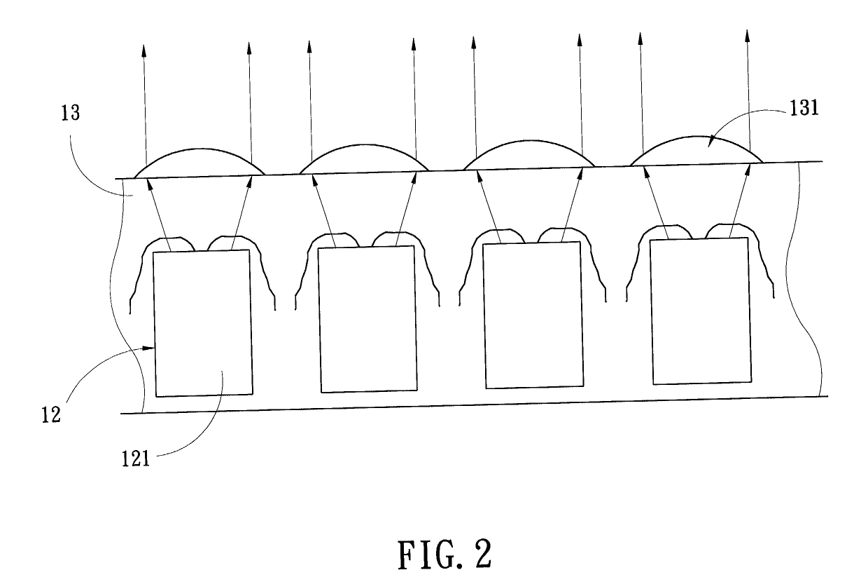

### DETAILED DESCRIPTION OF THE INVENTION

In order to obtain a surface light source with a high intensity and uniformity, and a small dispersion angle, the invention utilizes the monochromatic property of light emitting diodes (LEDs). Selecting industrial standard light bulb type packaged LED elements as the basis, a plurality of LED elements is closely disposed to form a coplanar surface type illuminator. By improving the shapes of the LED elements (the shapes of the transparent packages of the LED elements), any two adjacent LED elements do not leave any space in between. The alignment function of the convex lenses on top of the LED elements is still kept to obtain a surface light source generator with a high luminosity and uniformity and a small dispersion angle. If LED elements with a higher luminosity per unit area are selected, the unit area luminosity can be increased.

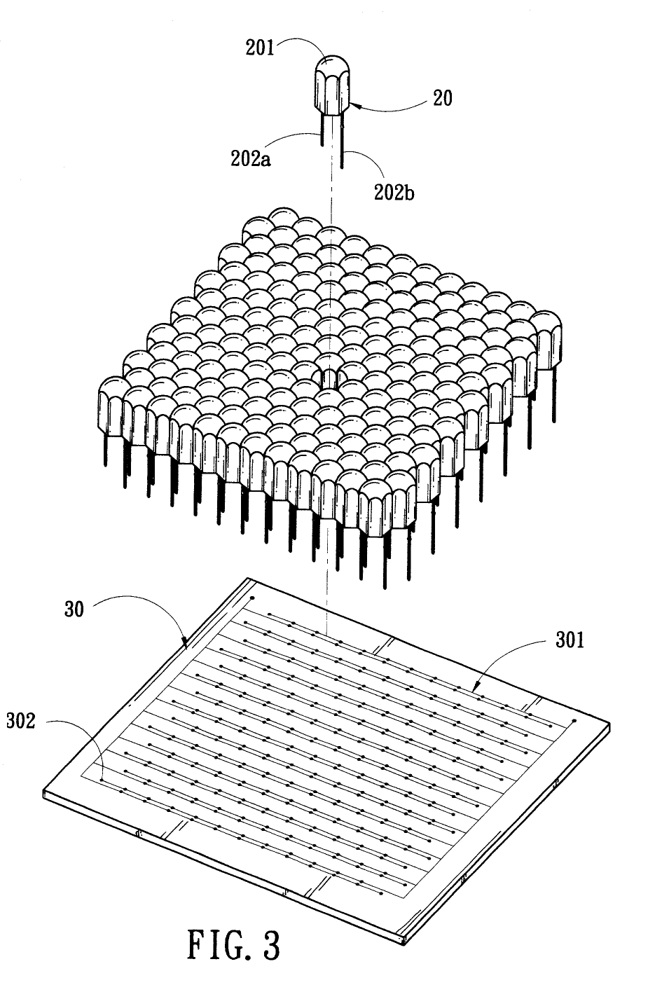

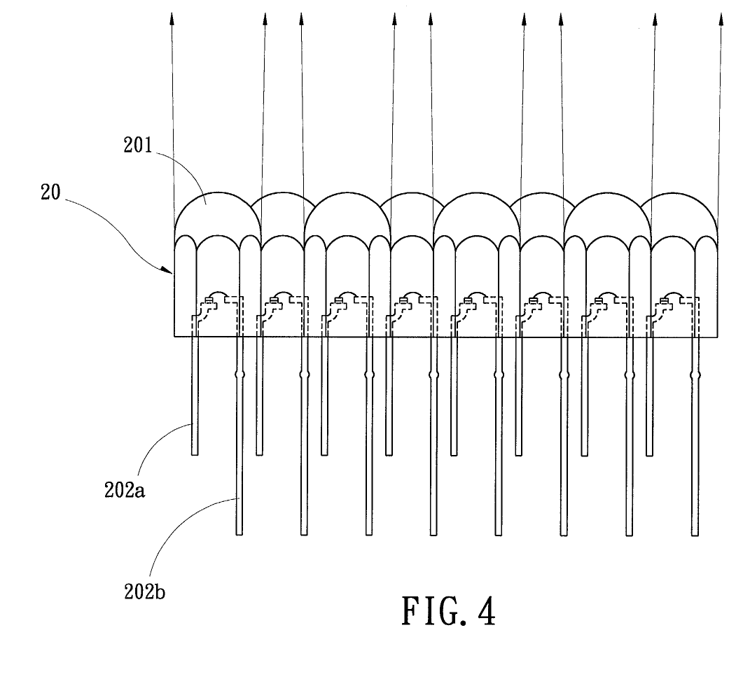

With reference to FIGS. 3 and 4, in a first preferred embodiment, any LED element 20 of the surface light source generator is in a hexagonal pillar shape. When many such LED elements 20 are packed together to form a surface, the rim and the hexagonal pillar surfaces form a naturally curved ridgeline. Its front view is just like an actual honeycomb. Any two adjacent LED elements 20 almost do not have any space in between, reaching the closest packing. The light emanating from the LED elements 20 will be refracted by the convex lenses 201 on top of the LED elements 20. The dispersion angle is controlled by the curvature of the convex lenses to be within 15 degrees. Since the LED elements 20 are closely packed together, a homogeneous surface light source is obtained without any dark area.

The LED elements 20 are soldered and installed on a circuit board 30. The surface of the circuit board 30 is distributed with circuits 301 (such as a printed circuit) and a plurality of holes 302 for accommodating pins 202a, 202b under the LED elements 20. By controlling the span between holes, many LED elements 20 can be closely disposed against one another after being soldered on the circuit board 30, forming a surface type light emitting area. Through the electrical communication between the circuit 301 and a driver (not shown), even if the circuit board surface does not have the circuit design 301 the pins 202a, 202b can still be soldered and fixed on the circuit board surface. Through the electric connection between the wires and the driver, soldering the LED elements 20 on the circuit board 30 can make no space exist between any two adjacent LED elements 20. Therefore, there will be no dark areas in the surface light source. If any LED element 20 is out of order, one can readily replace it using such simple tools as a solder. The maintenance is fairly simple, quick and cheap.

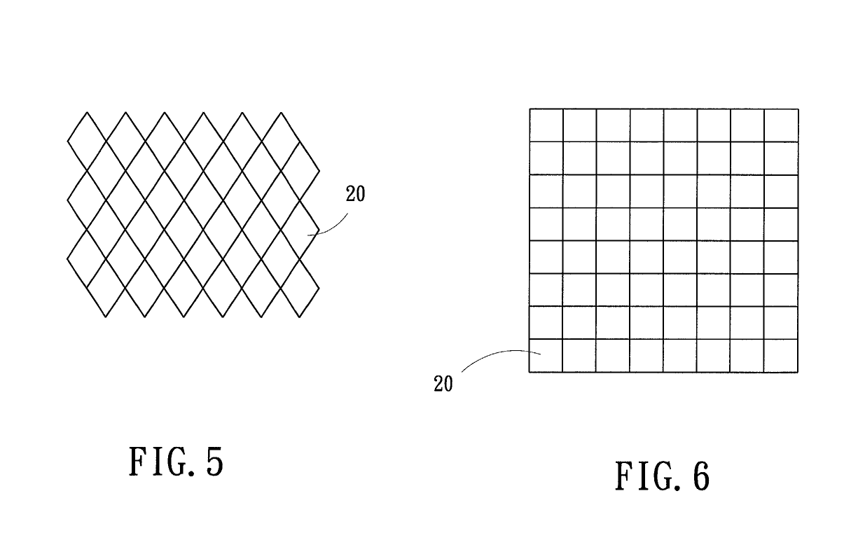

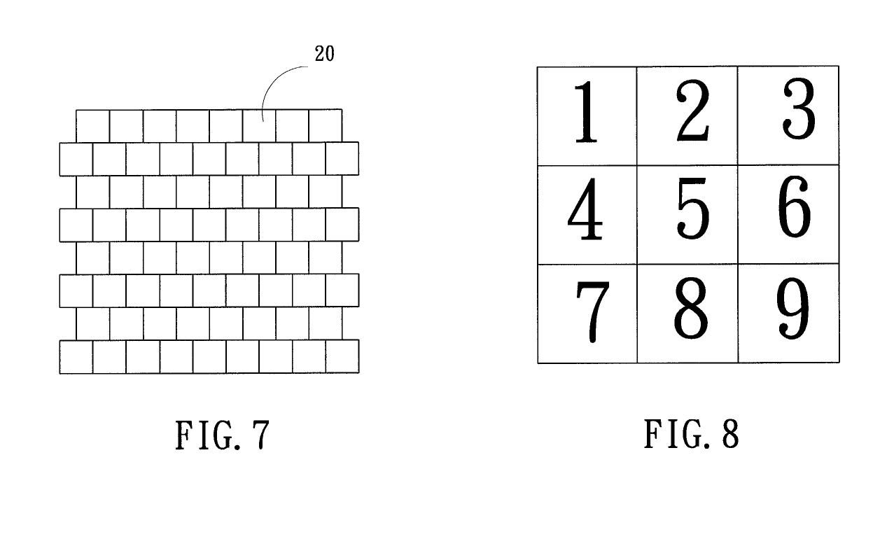

With reference to FIG. 5, according to another preferred embodiment, the LED elements 20 are in a quadrangle pillar shape; for example, diamond pillars or rectangular pillars. By disposing many such LED elements 20 together, a surface light source generator with homogeneous and even brighter light but no dark area at all can be constructed. Of course, the shape of the LED element 20 in yet another preferred embodiment can be a rectangular pillar, as shown in FIG. 6. Owing to the rectangular shape, the LED elements 20 can be disposed together in rows and columns or in the way shown in FIG. 7.

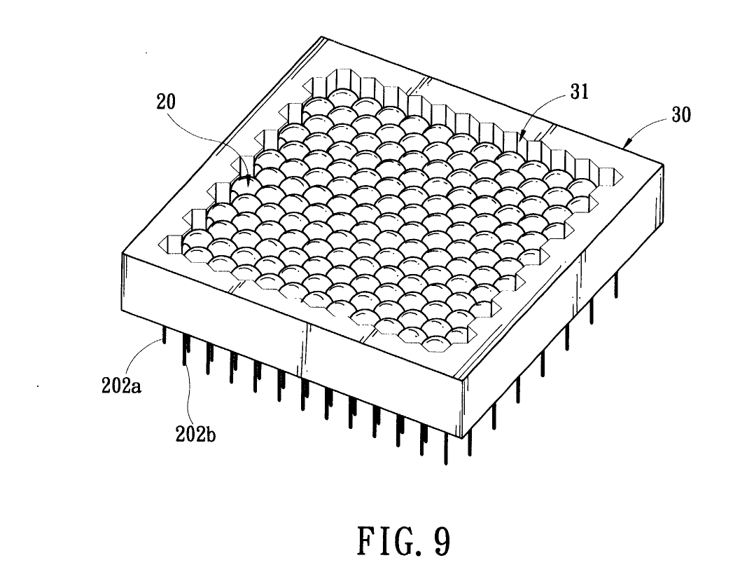

The present invention also comprises a last embodiment, as shown in FIG. 9. All LED elements 20 of the surface light source generator are placed in a reflector 30. The reflector 30 has a concave receiver 31 for contain the LED elements 20. In order to obtain high intensity, preferably to forming a reflective coating on the surface of receiver 31.

Effects of the Invention

If the conventional cylindrical LED elements are used to form a surface light source generator in a hexagonal pattern, roughly 9.3% of the area does not emit light because there is space between any two LED elements. Therefore, the present invention obviously can have full surface light emission with a higher luminosity, a better uniformity and no dim or dark area at all.

With reference to the experimental results shown in FIG. 8 and Table 1, they show the influence on the uniformity of emitted light when a few LED elements in the disclosed surface light source generator are out of order. In this experiment, we use hexagonal pillar LED elements with a dispersion angle of about 10 degrees are selected to be combined together to form a surface light source generator with an area of 26×33.6 cm². It is then separated into nine sampling areas numbered by 1 through 9, as shown in FIG. 8. The light uniformity of the nine sampling areas are measured under the following two conditions and listed in Table 1:

Condition 1: Full area emission; that is, the LED elements in each area are emitting light normally and none is out of order.

Condition 2: The LED elements at the center of the areas numbered by 5, 6 and 8 are set to be out of order without emitting light. The data shown in Table 1 takes the uniformity of the central area (numbered 5) in Condition 1 as the standard (100%). The values of the rest areas are measured relative to the above standard (under either Condition 1 or 2).

Therefore, from the sampling results of Table, one can realize that under Condition 2 the uniformity of the same area varies very little and has even less influence on the performance of the whole light source generator.

With reference to Table 2 showing another set of experimental results for the disclosed surface light source generator, one can see that:

1. As far as the visibility of the light source generator Contour and dark areas is concerned, using the hexagonal pillar LED elements with no dispersion angle will result in an apparent Contour and dark areas. On the contrary, using the ones with a 10 degrees of dispersion angle do not produce any Contour or dark areas.

2. Using hexagonal pillar LED elements with a dispersion angle of about 10˜15 degrees to form a surface light source generator, the range of uniformity in four LED elements surrounding the central point is between 52% and 73% when measured in the same way as in FIG. 8. The range of uniformity in four LED elements at the corners is between 27% and 35%. p1 3. Looking at the results shown in FIG. 8 and Table 1, the whole luminosity of the light source generator only varies slightly when three LED elements are out of order and the uniformity only decreases 0.7%. Even in the areas 5, 6 and 8 where the three LED elements do not emit light, the homogeneities also just drop by 1% to 3%.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

TABLE 1
Experimental Result

| | 10° | | 10° | | 10° |
|---|---|---|---|---|---|
| 10° | (Dispersion | 10° | (Dispersion | | (Dispersion |
| (Dispersion | angle) & 3 | (Dispersion | angle) & 3 | 10(Dispersion | angle) & 3 |
| angle) | defects | angle) | defects | angle) | defects |
| Area 1 | | Area 2 | | Area 3 | |
| 35% | 36% | 52% | 54% | 27% | 29% |
| Area 4 | | Area 5 | | Area 6 | |
| 73% | 67% | 100% | 97% | 52% | 49% |
| Area 7 | | Area 8 | | Area 9 | |
| 29% | 31% | 59% | 58% | 28% | 29% |

TABLE 2
Comparison

| | | |
|---|---|---|
| Contour and Dark | Lamp (Hexagonal) | Lamp (Hexagonal) |
| Area | Without a 10˜15° | With a 10˜15° Diffuser |
| | Diffuser | Disappear |
| | Seen | |
| Range of Uniformity | 4 spots around center | 4 corners |
| (with 10˜15° diffuser) | 52%˜73% | 27%˜35% |
| Defect Effect | Brightness | Uniformity |
| (3 Defects Vs | Little change | 0.7% decreasing for all; |
| without defect) | | 1%˜3% decreasing for |
| | | the defect areas (Spot |
| | | 5, 6, and 8) |

What is claimed is:

1. A surface light source generator comprising:
a plurality of industrial standard light bulb packaged light emitting diode (LED) elements, the plurality of LED elements having transparent packaging parts of the same shape and the plurality of transparent packaging parts are closely disposed into a coplanar surface type illuminator, wherein any two adjacent LED elements are closely packed and any LED element has a convex lens on its top and electrical pins extending downwards; and
a circuit board with holes for accommodating the electrical pins of the LED elements, the span of the holes being controlled so that the plurality of LED elements are closely disposed together after being fixed on the circuit board.

2. The surface light source generator of claim 1, wherein any of the transparent packaging parts of the LED elements is in a hexagonal pillar shape.

3. The surface light source generator of claim 1, wherein any of the transparent packaging parts of the LED elements is in a quadrangle pillar shape.

4. The surface light source generator of claim 1, wherein any of the transparent packaging parts of the LED elements is in a triangular pillar shape.

5. The surface light source generator of claim 1, wherein the circuit board further comprises a circuit connecting the holes.

6. The surface light source generator of claim 5, wherein any of the LED elements is soldered into the holes and has electrical communications with the circuit.

7. The surface light source generator of claim 1, wherein any of the LED elements is soldered onto the circuit board.

8. A surface-type illuminator comprising a plurality of industrial standard light bulb type packaging LED elements, the plurality of LED elements having transparent packaging parts of the same shape and the plurality of transparent packaging parts are closely disposed into a coplanar surface type illuminator, wherein any two adjacent LED elements are closely packed and any LED element has a convex lens on its top and electrical pins extending downwards.

9. The surface light source generator of claim 8, wherein any of the transparent packaging parts of the LED elements is in a hexagonal pillar shape.

10. The surface light source generator of claim 8, wherein any of the transparent packaging parts of the LED elements is in a quadrangle pillar shape.

11. The surface light source generator of claim 8, wherein any of the transparent packaging parts of the LED elements is in a triangular pillar shape.

12. The surface light source generator of claim 1, further comprising a reflector that has a concave receiver for contain the LED elements.

13. The surface light source generator of claim 12, further comprising a reflective coating formed on the surface of the receiver.
